(19) United States
(12) Patent Application Publication
(10) Pub. No.: US 2009/0211991 A1
(43) Pub. Date: Aug. 27, 2009

(54) Filtering a dispersed phase (e.g. oil) from a continuous liquid (e.g. water) of a dispersion

(75) Inventors: Serguei Rudolfovich Kosvintsev, Leicestershire (GB); Richard Graham Holdich, Leicestershire (GB); Iain William Cumming, Leicestershire (GB)

Correspondence Address: HARRINGTON & SMITH, PC, 4 RESEARCH DRIVE, Suite 202, SHELTON, CT, 06484-6212, US

(73) Assignee: Micropore Technologies Ltd.

(21) Appl. No.: 12/072,424

(22) Filed: Feb. 25, 2008

(51) Int. Cl. C02F 1/40; B01D 63/00; B01D 17/022; B01D 17/02

(52) U.S. Cl. 210/780; 210/500.21; 210/799; 210/384; 210/388

(57) ABSTRACT

Filtering a dispersed phase (e.g. oil) from a continuous liquid (e.g. water) of a dispersion a filter, for filtering a dispersed phase from a continuous liquid of a dispersion, the filter including a substrate having a plurality of apertures each extending directly through the substrate between a first surface and a second surface and a layer of material applied over at least a portion of the first surface, wherein the material rejects the continuous liquid to a greater extent than the dispersed liquid.

### FIELD OF THE INVENTION

Embodiments of the present invention relate to filtering a dispersed phase from a continuous liquid of a dispersion.

### BACKGROUND TO THE INVENTION

The removal of oil drops from water is a very important commercial process. For example, in the recovery of oil offshore seawater is often pumped into the oil reservoir to displace oil drops lying within the pores of the sandstone rock constituting the oil reservoir. A mixture of oil and water is recovered at the receiving oil platform. This is subjected to primary separation by gravity settling. The water content recovered from the reservoir may be 40% of the total flow and can be as high as 1000 m³ per hour. The water cleaned by the primary separation stage is unlikely to be acceptable for discharge to the surrounding sea because of environmental limits on permissible oil content. These limits vary according to locality, but limits of 30 to 40 ppm (parts per million by mass) are common. Hence, further treatment technologies are necessary. Some of these technologies, for example hydrocyclones, are less efficient when treating heavy oils and finer drops, whereas a filtration technique is still effective even when the drops have the same density as the surrounding water.

A coalescing filter can be used to separate oil from water. The filter receives the full flow of the dispersion to be filtered, perpendicular to a hydrophobic membrane. The oil drops are attracted to the hydrophobic surface of the membrane. Many drops collect together on the surface and form drops, or a film, much larger than the dispersed drops. The film, or large drops, become detached from the coalescing surface and float away from the filter reporting, eventually, to a layer above the water layer. JP2000126505 describes a coalescing filter in which a PTFE surface is used to attract oil drops and cause them to grow. A coalescing filter provides a very high membrane internal surface area in order to provide sites onto which coalescence may occur. For example, in EP0069885 and DE4426683 oil filters are described in which substantial filter packing is used to provide the surface area on which coalescence may occur.

Conventional microfilters normally employ a matrix in which particles, or drops, become trapped which results in a clean permeate from the system. Such performance is acceptable when the membrane filter is to be renewed, or replaced, but such performance is not acceptable when the filter must remain working for a long period in time, such as on an offshore oil platform.

### BRIEF DESCRIPTION OF THE INVENTION

According to one aspect of the invention there is provided a filter, for filtering a dispersed phase from a continuous liquid of a dispersion, the filter comprising a substrate having a plurality of apertures each extending directly through the substrate between a first surface and a second surface and a layer of material applied over at least a portion of the first surface, wherein the material rejects the continuous liquid to a greater extent than the dispersed liquid.

The material may be applied over all of the surface.

The filter may be a surface microfilter and the material may be applied over a filtering surface of the surface microfilter. The first and second surfaces may be substantially parallel and separated by a distance of 50-300 microns. Each aperture may provide a direct non-tortuous channels from a filtering side of the filter to a filtrate side of the filter.

Each aperture may have a minimum filtering dimension of less than 10 microns. Each aperture may be non-isotropic.

The substrate may be rigid.

The applied material may be hydrophobic and/or oleophilic. The applied material may be PTFE.

The dispersed phase may be drops of crude oil and the continuous liquid may be water.

The dispersed phase may be yeast cells.

According to one aspect of the invention there is provided a surface microfilter, for filtering oil from water, comprising: a substrate having a plurality of apertures extending through the substrate between a first surface and a second surface; and PTFE applied over at least a portion of the first filtering surface.

According to one aspect of the invention there is provided a system, for filtering a dispersed phase from a continuous liquid of a dispersion, the system comprising:

a container for containing the dispersion, the filter, a support for supporting the filter within the container so that the first surface of the filter contacts the dispersion;
a first mechanism for drawing the continuous liquid from the first surface of the filter to the second surface through the apertures of the filter; and a second mechanism for creating relative movement between the first surface of the filter and the dispersion.

The second mechanism may create a high shear at the first surface.

The second mechanism may oscillate the filter or the second mechanism may generate a cross-flow over the first surface or the second mechanism may rotate the filter or the second mechanism may rotate a member close to the first surface.

The second mechanism may be reversible causing some of previously filtered continuous liquid to flow back through the apertures of the filter into the dispersion.

According to one aspect of the invention there is provided the use of the filter in the extraction of crude oil from a dispersion of crude oil droplets in water

According to one aspect of the invention there is provided a method of filtering a dispersed phase from a continuous liquid of a dispersion, the filter comprising: drawing the continuous liquid from a first side of a filter to a second side of the filter through apertures extending directly through a substrate between the first side and the second side wherein the first side comprises material that rejects the continuous liquid to a greater extent than the dispersed liquid as determined by contact angle measurements performed in air.

The method may further comprising creating relative movement between the first side of the filter and the dispersion while drawing the continuous liquid from the first side of a filter to the second side of the filter.

### BRIEF DESCRIPTION OF THE DRAWINGS

For a better understanding of the present invention reference will now be made by way of example only to the accompanying drawings in which:

FIG. 1 illustrates a system 100, for filtering a dispersed phase 115 from a continuous liquid 106 of a dispersion 111;

FIG. 2 illustrates slotted aperture filtration

FIG. 3 illustrates the rejection of particles and oil drops at the surface of the membrane; and

FIG. 4 illustrates an oil drop rejection curve.

### DETAILED DESCRIPTION OF THE INVENTION

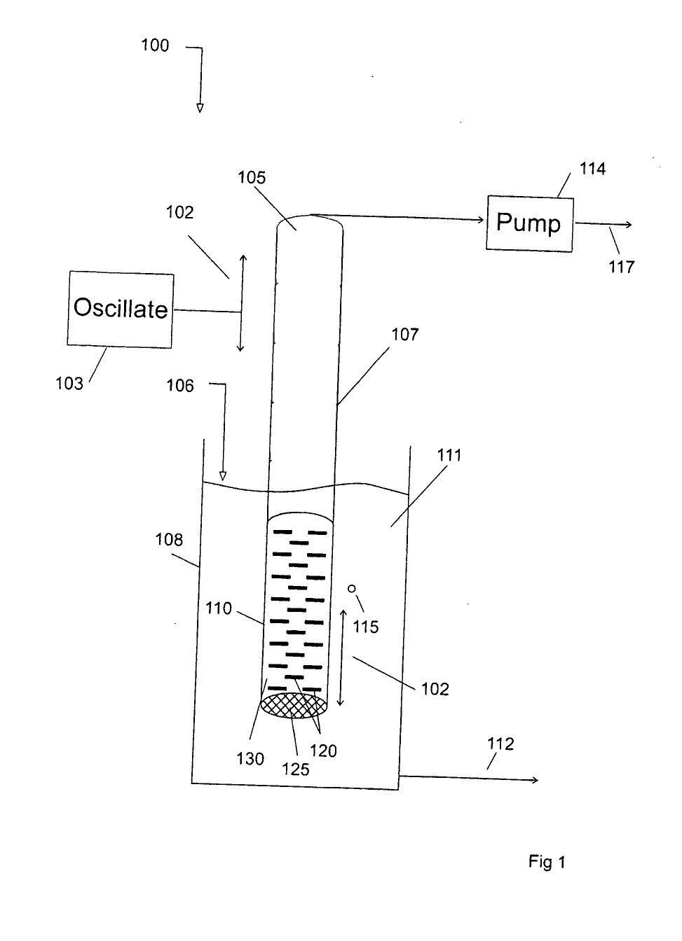

FIG. 1 illustrates a system 100, for filtering a dispersed phase 115 from a continuous liquid 106 of a dispersion 111. The example illustrated uses a surface microfilter for extracting crude oil from a dispersion of crude oil droplets in water

A surface microfilter is one in which particles, or drops, are retained on a filtering surface of the filter and are not captured within a filter matrix. For the purpose of filtration over many days, rather than in a single batch, shear is provided at the microfilter filtering surface, to prevent build up of deposited material. Hence, the filtration is determined by the properties of the membrane and not by the deposited material.

The system 100 comprises: a container 108 for containing the dispersion 111, a perforated surface microfilter 105, a support for supporting the filter so that it is at least partially immersed in the dispersion, a first mechanism 114 for drawing the continuous liquid through the filter 105; and a second mechanism 103 for creating relative movement 102 between the filter 110 and the dispersion 111.

The filter 105 is suitable for filtering a dispersed phase 115 from a continuous liquid of a dispersion 111. The filter 105 comprises a tubular membrane 110 that comprises an impervious substrate 107 having a surface coating 130 and a plurality of apertures 120 arranged in an array. Each aperture 120 extends directly through the substrate 107 providing a direct non-tortuous channel between a first surface on the exterior of the tubular membrane 110 that contacts the dispersion 111 and a second surface on the interior of the tubular membrane. The first and second surfaces are substantially parallel and separated by 50 to 300 microns.

A layer of material that rejects the continuous liquid 106 to a greater extent than the dispersed phase 115 is applied over the first exterior surface. That is, the contact angle of the continuous liquid 106 on the material, when measured in air, is significantly greater than the contact angle of the dispersed liquid 115 on the material, when measured in air.

The contact angle of the continuous liquid 106 on the material, when measured in air, may be greater than 90 degrees. If the continuous liquid 106 is water, the material is called ‘hydrophobic’.

The contact angle of the dispersed phase 115 on the material, when measured in air, may less than 90 degrees. If the dispersed liquid 115 is an oil, the material is called ‘oleophilic’.

The material may be polytetrafluoroethylene (PTFE). The contact angle of water on a PTFE surface is approximately 110 degrees and the contact angle of an oil (e.g. hexadecane) is approximately 60 degrees when measured in air—implying that the PTFE surface would attract oil in preference to water. Such a hydrophobic substance would not normally be expected to provide good oil drop filtration performance whilst filtering from water.

The pump mechanism 114 draws the continuous liquid 106 from the volume of the container 108 adjacent the first exterior surface of the surface microfilter membrane 110 to the interior of the tubular membrane through the apertures 120 and discharges it as permeate 117. The tubular membrane 110 has an impervious end 125 so that the continuous liquid (water) only enters the interior of the tubular microfilter via the apertures 120.

The second mechanism 102 generates shear at the exterior surface of a microfilter 110 by creating relative movement between the exterior surface of the filter and the dispersion. One technique, is cross-flow microfiltration in which the dispersion to be filtered is pumped over the surface of the filter in a direction parallel to the filtering surface. A major disadvantage of cross-flow microfiltration is the need to recycle dispersion over the surface of the filter repeatedly, in order to generate the surface shear. Other techniques for generating shear are rotating the surface microfilter within the dispersion 111 and rotating a member close to the exterior surface to create fluid flow. A very effective method of generating surface shear that does not require the repeated pumping of dispersion is to linearly oscillate the tubular membrane along the axis of the tube. An electronically or pneumatically driven oscillating mechanism 103 oscillates 102 the surface microfilter 105. The oscillations 102 are along the axis of the tubular membrane 110 and are the same over the entire surface of the tubular membrane 110. Rigidity in the substrate of the membrane 110 enables the linear oscillatory motion to be transmitted along the entire length of the membrane without any damping. Thus, high shear can be applied over the entire membrane surface at the same time.

In use, the continuous liquid 106 passes through the filter membrane 110 and the oil drops within the dispersion 111 are rejected by the PTFE on the filtering membrane 110 and may be discharged from the vessel 108 by a bleed flow 112.

The PTFE coating on the surface membrane is not present to provide coalescence, it is used to reject the dispersed oil drops in the flow. The main flow of liquid is parallel to the exterior membrane surface and not perpendicular to it. Drops at the membrane surface are not allowed sufficient time to coalesce, as the surface shear and back-pulsing removes them from the surface.

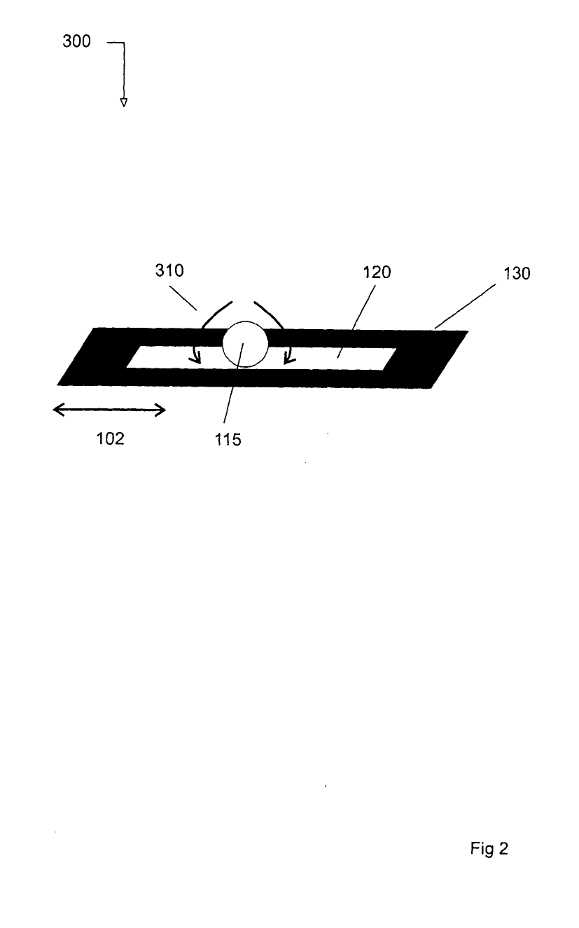

The apertures 120 are preferably non-isotropic and have a minimum filtering dimension of less than 10 microns. The isotropy is relative to the first exterior surface of the membrane 110. In the illustrated example, each aperture is a slot with a width of 4 microns and a length of 400 microns. The slotted aperture filtration is illustrated in FIG. 2. The use of a slotted aperture 120 reduces the likelihood of passage of oil drops 115 to the permeate 117. This is because a drop of oil is very unlikely to entirely block off an non-isotropic aperture. A drop may transfer from the membrane surface into the permeate by liquid drag over the surface of the drop, if the drag force is sufficient to cause the drop to deform and pass through the slot aperture. However, if the drag force is insufficient, then the drop will remain on the membrane surface until it is sheared away by the shear forces imposed by the bulk flow 102. By contrast, a circular pore surface membrane may be blocked by a spherical drop and in these conditions the force pushing the drop into the permeate 117 will be the entire pressure differential across the membrane.

A non-isotropic pore geometry provides a further advantage in overcoming the natural tendency of gas bubbles to adhere to the microfiltration membrane apertures. The bubbles may be entrained gas from the surrounding atmosphere, or they may be gases dissolved in the liquid coming out of solution on a reduction of solution pressure—possibly caused by the filtration process. When filtering with circular pores the gas bubbles often attach to the pore opening and remain there. However, when filtering with a non-isotropic pore the gas bubble will not block off the entire flow through the pore, for the same reasons detailed above when considering oil drops at the pore opening. Thus, a non-circular pore geometry provides a significant advantage in overcoming filtration resistance due to gas bubbles which may occur, and remain, at the membrane surface. A further technique may be applied to remove these bubbles: a momentary flow reversal through the membrane pores.

High shear at the membrane surface is effective at removing, or avoiding the deposition of, a large amount of material but, despite this, it is usual for a small amount of material, or gas bubbles, to build up at the membrane surface. If an additional method for removal of these is not applied then it is likely that filtration performance would continuously decline. A simple additional method to remove the accumulation of this material is to provide a back-flush, or a back-pulse, of previously filtered liquid through the membrane. The pump mechanism 114 is reversible causing some of previously filtered continuous liquid 106 to flow back through the apertures 120 of the filter into the dispersion 111. A quick reversal of flow dislodges the accumulating material at the exterior surface of the membrane 110. The dislodged material is then caught in the high shear 102 at the membrane surface and removed. A surface microfilter 105 has a particular advantage in the application of back-pulsing, as it possesses apertures 120 that pass directly through the membrane 110 from the permeate side to the filtering surface. Thus, back-pulse flow is not impeded by the filter matrix and provides a high liquid flow at the aperture opening.

The surface microfilter 105 may be manufactured by forming a substrate in accordance with the procedure described in published UK patent application GB2385008A. A PTFE coating was applied by spray coating, using commercially available PTFE lubricant and then baked at 320° C. in an oven for 2 minutes. The process did not measurably alter the pore size of the filter, which was a slot width of 4 microns and a slot length of 400 microns.

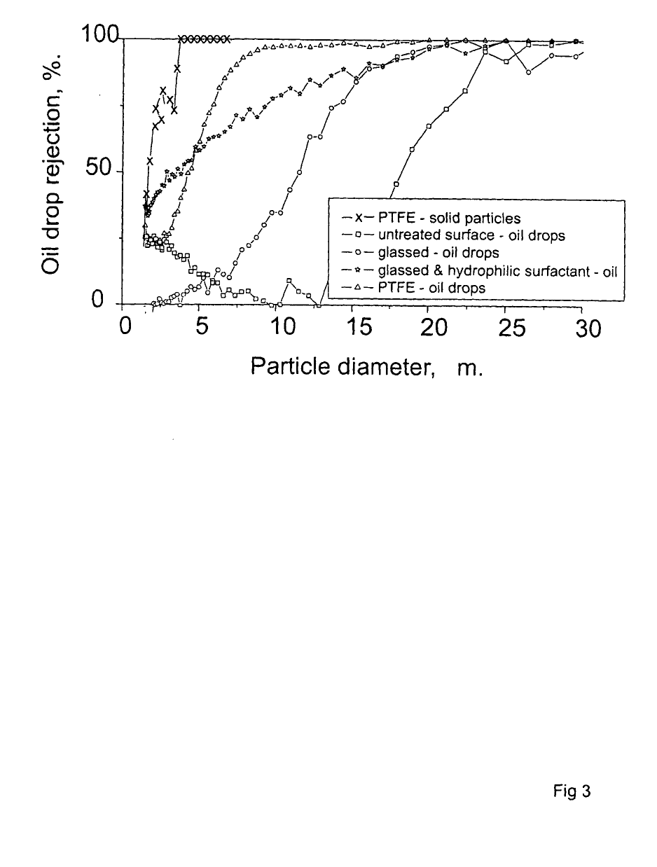

The resulting filter was tested by a challenge suspension containing solid particles and a separate dispersion containing oil drops with diameters up to 50 microns in diameter, and a mean size of 10 microns. The results from this test are compared with tests using the same substrate material, a slotted microfilter with slot width of 4 microns, but with alternative surface properties: uncoated, coated by a layer of glass applied by a sol-gel process and coated by a layer of glass with an additional very hydrophilic surfactant added. The filtration conditions for all these tests were: cross-flow filtration with a differential pressure between the feed and permeate of 40 to 80 mbar and a permeate flux rate of 4500 litres of permeate per square metre of membrane per hour. The solid particles used in the challenge suspension were polymer latex with a mean size of 6 microns. The crude oil concentration in the challenge dispersion was 660 parts per million (ppm), dispersed in seawater by means of a homogeniser. FIG. 3 illustrates the rejection of particles and oil drops at the surface of the membrane. The highest rejection efficiency is for solid particles, where no particles bigger than 4 microns are shown to have entered the permeate. This is consistent with a slot width of 4 microns. The best oil drop rejection performance is provided by the PTFE coating, which is much more efficient at rejecting oil drops greater than 5 microns than the hydrophilic, and very hydrophilic, coatings under the same operating conditions.

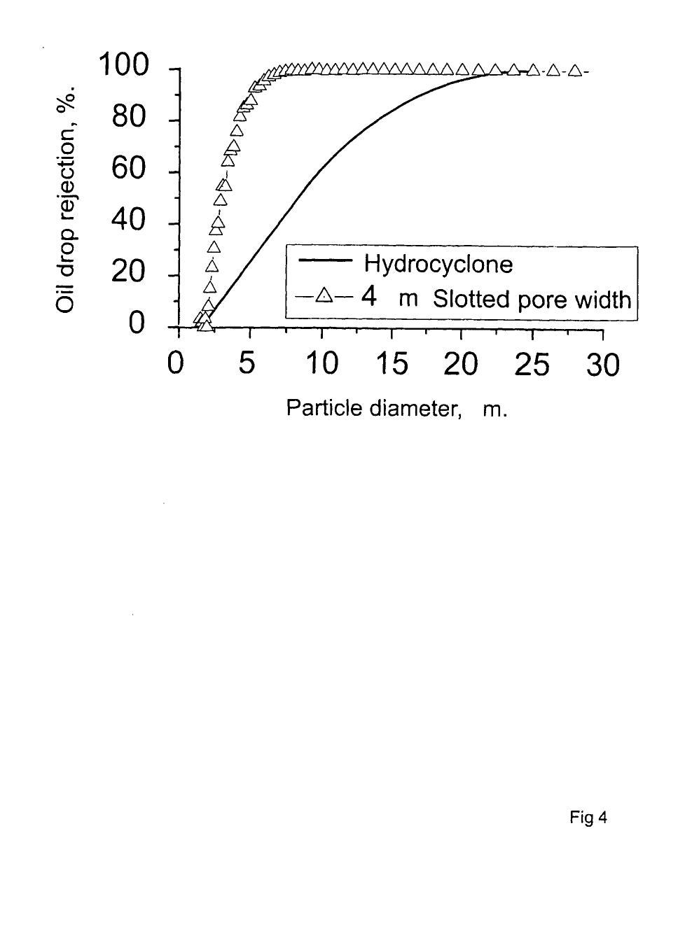

A similar filter was produced and formed into a tube and vibrated in equipment similar to that illustrated in FIG. 1. For test purposes, a single tube with length 40 mm and tube diameter 14 mm was used. The vibration was achieved by means of a linear pneumatically driven vibrator (FAL 8 from Vibtec Ltd., Brighton). The frequency was 20 Hz and the amplitude of vibration was 8 mm. The crude oil drop concentration was 400 ppm and the filtration flux rate was 1200 litres per square metre of membrane area per hour. The oil drop rejection curve is shown in FIG. 4, together with an illustrative comparison curve of the efficiency of a hydrocyclone operating on crude oil. Under these conditions, the microfiltration process provides 100% rejection of oil drops down to sizes of 8 microns and still provides 50% efficiency with oil drops 3 microns in diameter.

Although embodiments of the present invention have been described in the preceding paragraphs with reference to various examples, it should be appreciated that modifications to the examples given can be made without departing from the scope of the invention as claimed. For example the dispersed phase may be yeast cells.

In one embodiment, the system 100 illustrated in FIG. 1 may be used to generate emulsions by dispersing a first phase in a second phase. In this embodiment, a first phase is provided to the surface microfilter 105 by the first mechanism 114. The first phase egresses (by means of the first mechanism 114) from the interior surface of the microfilter 105 to the exterior surface of the microfilter 105 and is dispersed in the second phase contained in the container 108 thereby generating an emulsion.

The second mechanism 103 is configured to generate relative movement 102 between the filter 105 and the second phase. The relative movement 102 between the filter 105 and the second phase may develop a consistent oscillatory shear field in the second phase contained in the container 108. The oscillatory shear field is consistent over the plurality of apertures 120. Thus, the first phase as it emerges through each of the apertures 120 is subject to the same consistent oscillatory shear field perpendicular to the direction of egress. This enables the formation of drops of the first phase within the second phase that are of consistent size.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

A filter, for filtering a dispersed phase from a continuous liquid of a dispersion, the filter comprising a substrate having a plurality of apertures each extending directly through the substrate between a first surface and a second surface and a layer of material applied over at least a portion of the first surface, wherein the material rejects the continuous liquid to a greater extent than the dispersed liquid.

The material may be applied over all of the surface. The filter may be a surface microfilter and the material may be applied over a filtering surface of the surface microfilter. The first and second surfaces may be substantially parallel and separated by a distance of 50-300 microns.

Each aperture may provide a direct non-tortuous channels from a filtering side of the filter to a filtrate side of the filter. Each aperture may have a minimum filtering dimension of less than 10 microns. Each aperture may be non-isotropic.

The substrate may be rigid. The applied material may be hydrophobic. The applied material may be PTFE.

The dispersed phase may be drops of crude oil. The continuous liquid may be water. The dispersed phase may be yeast cells.

A surface microfilter, for filtering oil from water, comprising: a substrate having a plurality of apertures extending through the substrate between a first surface and a second surface; and PTFE applied over at least a portion of the first filtering surface.

A system, for filtering a dispersed phase from a continuous liquid of a dispersion, the system comprising: a container for containing the dispersion; a filter as described in any of the preceding paragraphs; a support for supporting the filter within the container so that the first surface of the filter contacts the dispersion; a first mechanism for drawing the continuous liquid from the first surface of the filter to the second surface through the apertures of the filter; and a second mechanism for creating relative movement between the first surface of the filter and the dispersion.

The second mechanism may create a high shear at the first surface. The second mechanism may oscillate the filter. The second mechanism may generate a cross-flow over the first surface. The second mechanism may rotate the filter. The second mechanism may rotate a member close to the first surface. The second mechanism may reversible cause some of previously filtered continuous liquid to flow back through the apertures of the filter into the dispersion.

The use of the filter as described in any of the preceding paragraphs in the extraction of crude oil from a dispersion of crude oil droplets in water

The use of the system as described in any of the preceding paragraphs in the extraction of crude oil from a dispersion of crude oil droplets in water

A method of filtering a dispersed phase from a continuous liquid of a dispersion, the filter comprising: drawing the continuous liquid from a first side of a filter to a second side of the filter through apertures extending directly through a substrate between the first side and the second side wherein the first side comprises material that rejects the continuous liquid to a greater extent than the dispersed liquid.

The method may further comprise creating relative movement between the first side of the filter and the dispersion while drawing the continuous liquid from the first side of a filter to the second side of the filter.

1. A system comprising:
a container for containing a dispersion
a filter comprising a substrate having a plurality of apertures each extending directly through the substrate between a first surface and a second surface and a layer of material applied over at least a portion of the first surface, wherein the material rejects continuous liquid to a greater extent than dispersed liquid,
a support for supporting the filter within the container so that the first surface of the filter contacts the dispersion;
a first mechanism for drawing liquid through the apertures of the filter; and
a second mechanism for creating relative movement between the first surface of the filter and the dispersion.

2. A system as claimed in claim 1, wherein the material is applied over all of the surface.

3. A system as claimed in claim 1, wherein the filter is a surface microfilter and the material is applied over a filtering surface of the surface microfilter.

4. A system as claimed in claim 1, wherein the first and second surfaces are substantially parallel and separated by a distance of 50-300 microns.

5. A system as claimed in claim 1, wherein each aperture provides a direct non-tortuous channels from a filtering side of the filter to a filtrate side of the filter.

6. A system as claimed in claim 1, wherein each aperture has a minimum filtering dimension of less than 10 microns.

7. A system as claimed in claim 1, wherein each aperture is non-isotropic.

8. A system as claimed in claim 1, wherein the substrate is rigid.

9. A system as claimed in claim 1, wherein the applied material is hydrophobic.

10. A system as claimed in claim 1, wherein the applied material is PTFE.

11. A system as claimed in claim 1, wherein the dispersed phase is drops of crude oil.

12. A system as claimed in claim 1, wherein the continuous liquid is water.

13. A system as claimed in claim 1, wherein the dispersed phase is yeast cells.

14. A system as claimed in claim 1, wherein the second mechanism creates a high shear at the first surface.

15. A system as claimed in claim 1, wherein the second mechanism oscillates the filter.

16. A system as claimed in claim 1, wherein the second mechanism generates a cross-flow over the first surface.

17. A system as claimed in claim 1, wherein the second mechanism rotates the filter.

18. A system as claimed in claim 1, wherein the second mechanism rotates a member close to the first surface.

19. A system as claimed in claim 1, wherein the second mechanism is reversible causing some of previously filtered continuous liquid to flow back through the apertures of the filter into the dispersion.

20. The use of the system as claimed in claim 1 in the extraction of crude oil from a dispersion of crude oil droplets in water.

21. A method comprising:
drawing liquid through apertures of a filter which extend directly through a substrate between a first side and a second side wherein the first side comprises material that rejects continuous liquid to a greater extent than dispersed liquid; and
creating relative movement between the first side of the filter and a dispersion while drawing the liquid through the apertures.
